(19) United States
(12) Patent Application Publication
(10) Pub. No.: US 2024/0005511 A1
(43) Pub. Date: Jan. 4, 2024

(54) Immediate Proximity Detection and Breakthrough with Visual Treatment

(71) Applicant: Apple Inc., Cupertino, CA (US)

(72) Inventors: Maxime Uzan, Harnes (FR); Edwin Iskandar, San Jose, CA (US); Ming Chuang, Bellevue, WA (US); Pavel V. Dudrenov, San Francisco, CA (US)

(21) Appl. No.: 18/345,850

(22) Filed: Jun. 30, 2023

Related U.S. Application Data
(60) Provisional application No. 63/367,401, filed on Jun. 30, 2022.

(51) Int. Cl. G06T 7/11; G06T 15/00; G06T 13/00; G06T 7/70

(52) U.S. Cl. CPC G06T 7/11; G06T 15/005; G06T 2207/20021; G06T 7/70; G06T 13/00

(57) ABSTRACT

Providing a visual treatment based on proximity to an obstruction includes collecting, by a device, a sensor data for an environment, determining a status for each of a plurality of regions of the environment, where at least one region of the environment is assigned an occupied status, and in accordance with a determination that the device satisfies a predetermined closeness threshold to the at least one region of the environment assigned an occupied status, causing a visual treatment to be rendered by the device, where the visual treatment indicates a location of the at least one region of the environment having an occupied status.

### BACKGROUND

Many multifunctional electronic devices are capable of generating and presenting extended reality (“XR”) content. Often, these devices utilize an immersive display, such as a heads-up display, by which a user can interact with the XR content. The XR content may wholly or partially simulate an environment that people sense and/or interact with via the electronic device. However, by the very nature of the immersive experience, a user may be distracted from a surrounding physical environment, which may lead to a user being unaware of objects in a physical environment.

### BRIEF DESCRIPTION OF THE DRAWINGS

FIGS. 1A-1C show example system setups in which the disclosure may be practiced according to one or more embodiments.

FIGS. 2A-2C shows alternative views of an example system setup, according to one or more embodiments.

FIG. 3 shows, in flowchart form, a technique for allocating status information to blocks in an environment in accordance with one or more embodiments.

FIG. 4 shows, in flowchart form, a technique for applying a visual treatment to image content, according to one or more embodiments.

FIG. 5 shows an example system diagram of an electronic device, according to one or more embodiments.

FIG. 6 shows, in block diagram form, a simplified multifunctional device according to one or more embodiments.

### DETAILED DESCRIPTION

This disclosure is directed to systems, methods, and computer readable media for immediate proximity detection and breakthrough with visual treatment. In general, techniques are disclosed to modify a presentation on a display to indicate physical objects in an immediate proximity of a user when the user is participating in an immersive experience, such as augmented reality, virtual reality, extended reality, and the like. A physical environment around a device may be quantized into environment blocks, and as the device moves around the environment, the device can collect sensor data to determine whether the various individual environment blocks are occupied, not occupied, or whether a status of the block is unknown. According to some embodiments, if a block is determined to be occupied, and is within a predetermined threshold distance, then a visual treatment may be applied to the image content presented to the user such that the user is made aware that the user is within a proximity of a physical object in the physical environment.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed embodiments. In this context, it should be understood that references to numbered drawing elements without associated identifiers (e.g., 100) refer to all instances of the drawing element with identifiers (e.g., 100a and 100b). Further, as part of this description, some of this disclosure's drawings may be provided in the form of a flow diagram. The boxes in any particular flow diagram may be presented in a particular order. However, it should be understood that the particular flow of any flow diagram is used only to exemplify one embodiment. In other embodiments, any of the various components depicted in the flow diagram may be deleted, or the components may be performed in a different order, or even concurrently. In addition, other embodiments may include additional steps not depicted as part of the flow diagram. The language used in this disclosure has been principally selected for readability and instructional purposes and may not have been selected to delineate or circumscribe the disclosed subject matter. Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

It should be appreciated that in the development of any actual implementation (as in any development project), numerous decisions must be made to achieve the developers' specific goals (e.g., compliance with system and business-related constraints), and that these goals will vary from one implementation to another. It will also be appreciated that such development efforts might be complex and time consuming but would nevertheless be a routine undertaking for those of ordinary skill in the art of image capture having the benefit of this disclosure.

A physical environment refers to a physical world that people can sense and/or interact with or without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

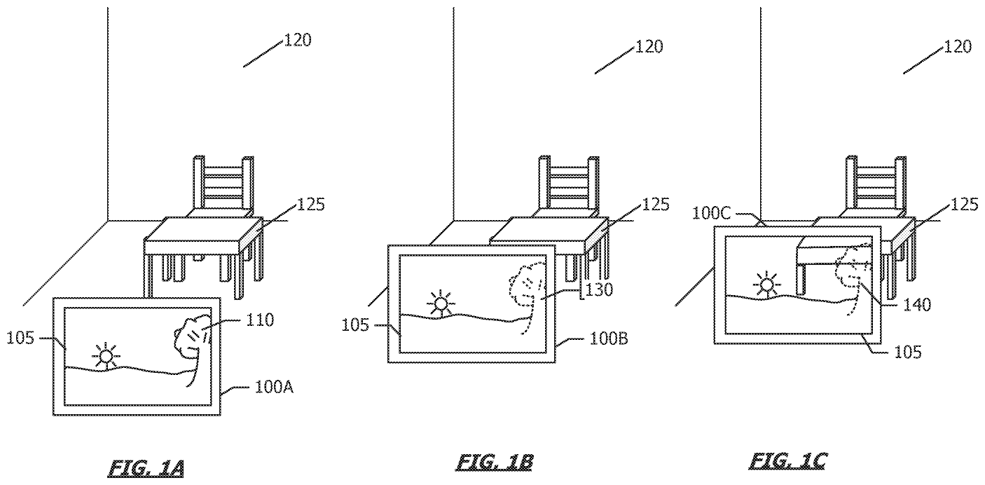

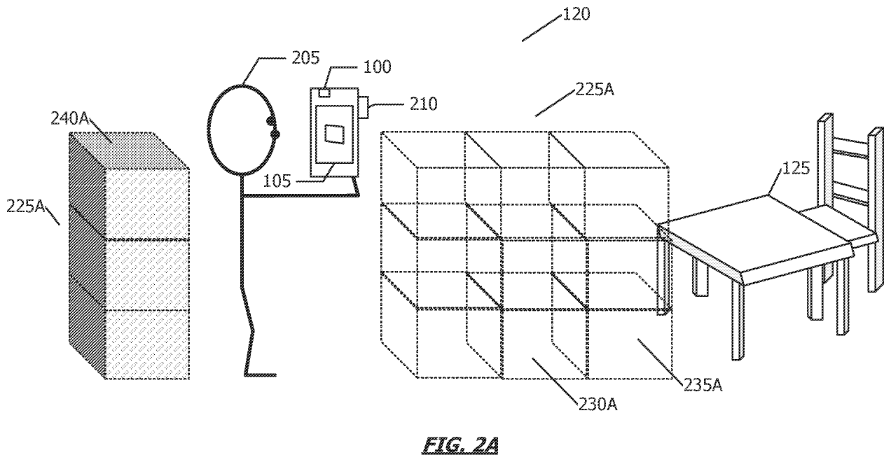

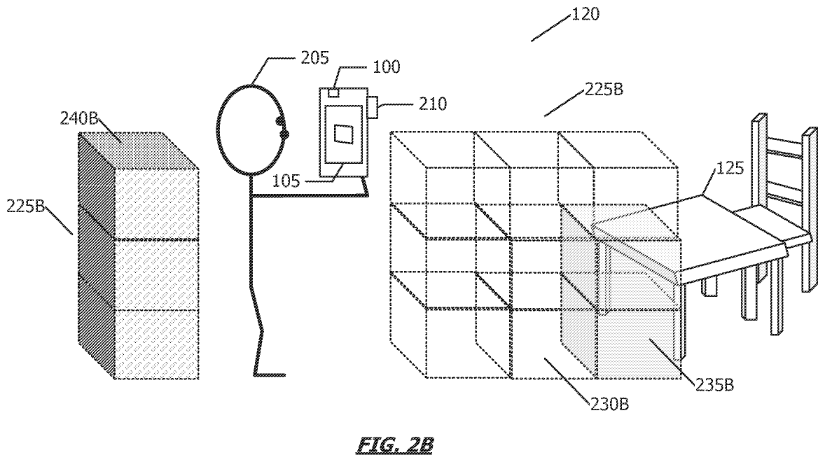

Referring to FIGS. 1A-1C, an example system setup is presented in which the disclosure may be practiced according to one or more embodiments. In particular, FIG. 1A shows an example electronic device 100A having a display 105 on which virtual content 110 is presented. For purposes of clarity, electronic device 100A refers to an electronic device at a first location. As will be described below, electronic device at a second location will be referred to as 100B, and the electronic device at a third location will be referred to as 100C. As such, the reference number 100 will refer to the electronic device regardless of location.

Virtual content 110 may include augmented reality content, virtual reality content, or any kind of extended reality content. Virtual content may be presented, for example, while the user is involved in an immersive experience. The display 105 may be an opaque display, an immersive display such as an optical see-through display, or the like. A user may use electronic device 100 to view the virtual content 110 while the user is within a physical environment 120. The virtual content 110 may be presented using an initial visual treatment. For example, in some embodiments the virtual content 110 may be presented on the display 105 in a manner irrespective of physical characteristics of the real environment 120. As another example, in some embodiments the virtual content 110 may be presented in a manner such that at least some physical objects in the physical environment 120, such as desk 125 are not visible to a user. According to some embodiments, the device 100 can be configured to track whether any physical objects are within a predetermined proximity. Physical object in the environment may include, for example, static objects such as furniture, walls, doors, fixtures, and the like. Physical objects may also include dynamic objects such as pets, animals, people, or other objects which may be moving through the environment. The device 100 may quantize an environment around the device, such as directly in front of the device, surrounding the device, or the like, into blocks of space. The device can include sensors, such as depth cameras, LIDAR, or the like, which may be used to determine whether any of the blocks of space contain a physical object. According to some embodiments, when the device begins an immersive experience, a determination may be made that the blocks in the proximate region of the device are unoccupied.

According to some embodiments, techniques described herein augment the presentation of virtual content presented to a user of the device 100 within an immersive application when the user approaches a physical object in order to make the user aware of physical surroundings. Turning to FIG. 1B, an example system setup is shown where the device 100B is at a second location in the physical environment 120, closer to a physical object. In this example, the electronic device 100B is approaching a physical desk 125 in the physical environment 120. In some embodiments, as the device 100 moves through the environment 120, the device 100 can determine whether any of the quantized blocks of space are occupied by a physical object. In some embodiments, as will be described below, the device 100 may determine whether any of the quantized blocks of space are occupied by collecting sensor data, such as depth information, LIDAR, or the like, to determine an occupied status. If the device 100 is within a predetermined distance of a physical object, then the device 100 can modify the presentation on the display 105 by applying a visual treatment which acts as an indication to the user of the device that a physical object is within a predetermined proximity of the electronic device 100.

In the example of FIG. 1B, the electronic device 100B is within a first predetermined proximity of the desk 125. As such, a first visual treatment 130 is applied to the virtual content. For purposes of the example of FIG. 1B, a dashed line is applied to the virtual tree, which is presented at a portion of the display 105 of the electronic device 100B proximate to the physical desk 125 in the physical environment 120. The visual treatment may include, for example, an animation, change in color, or other modification to a virtual object. Further, in some embodiments, the virtual treatment may include changes to the presentation to the user, such as causing a breakthrough display such that the physical object, or characteristics of the physical object, are made visible to the user. According to some embodiments, various visual treatments may be applied, and a particular visual treatment may be selected based on a proximity of the device, or a user of the device, to the physical object. For example, different predetermined distances may be associated with different visual treatments. As another example, a visual treatment may be applied dynamically as a user approaches the physical object. For example, a particular animation or color change may be applied in a manner that is more apparent as the user approaches the physical object.

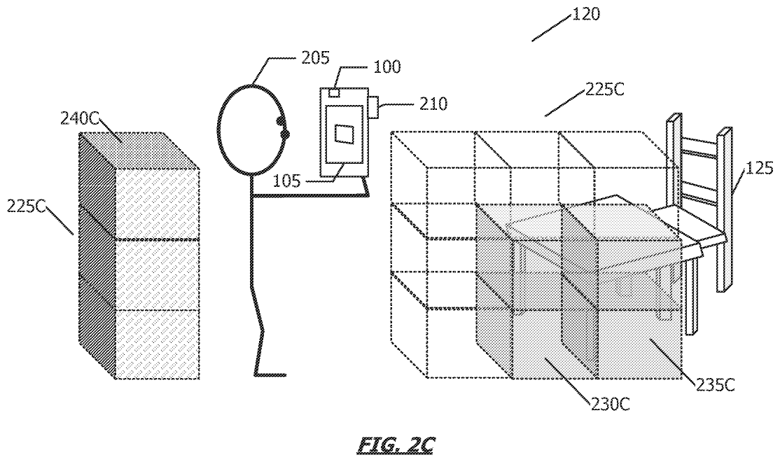

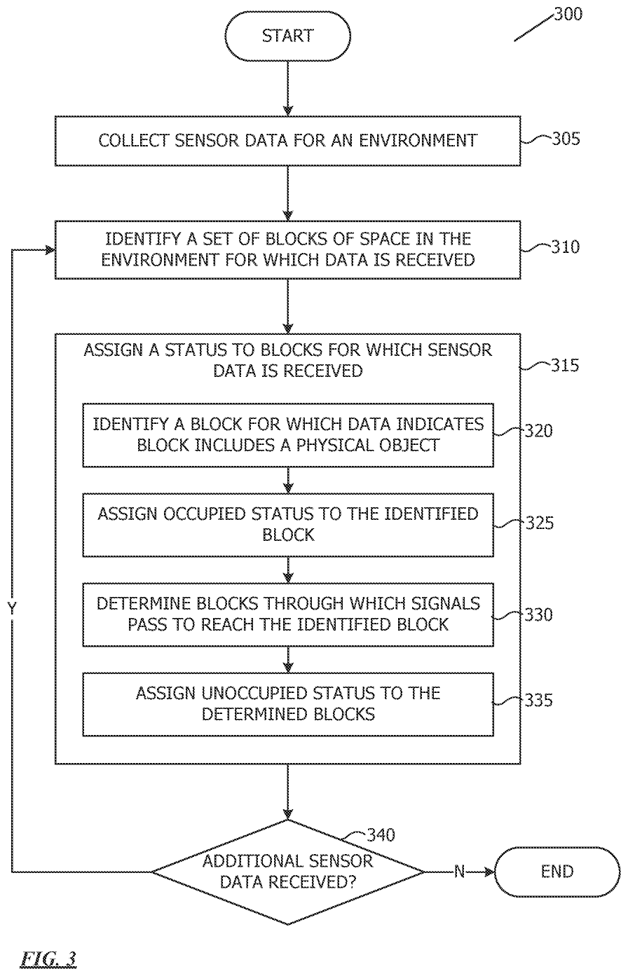

As will be described in greater detail below with respect to FIG. 2, the device 100 may quantize a portion the physical environment 120 around the device 100 to determine whether each of a set of quantized regions are occupied, unoccupied, or have an unknown status. As such, the determination of whether a predetermined distance is satisfied may be based on a determination that a block that is determined to be occupied is within a predetermined distance of the device 100.

Turning to FIG. 1C, a third example is shown, where electronic device 100C is at a third location in the physical environment 120 and is closer to the physical desk 125 than in the examples of FIG. 1A and FIG. 1B. In some embodiments, the device 100C may determine that a second predetermined distance is satisfied from an occupied block, for example, because the block is occupied due to the physical desk 125. As such, the device may apply another visual treatment to the virtual content presented on the display 105. For example, in some embodiments, a change in color or other image characteristic may be applied, or an animation or other graphic may be applied. Further, as shown in FIG. 1C, a pass-through treatment may be applied such that the user is able to view the physical desk 125 that would otherwise be obstructed by the virtual content. In some embodiments, the pass-through treatment may include modifying the virtual content presented on a pass-through display such that the physical object, such as physical desk 125, is visible. As another example, the device 100C may capture an image of the physical device 125 and present the image on the display 105 such that the user is able to determine that the physical object is within a predetermined proximity. According to one or more embodiments, by applying the various visual treatments, the electronic device 100 can indicate to the user that a physical object, which may otherwise not be apparent to the user, is within a predetermined proximity. As such, the user is able to be more aware of the physical objects in the environment.

Turning to FIG. 2A, an alternative view of an example system setup is depicted, according to one or more embodiments. In particular, FIG. 2A shows a view of a physical environment 120 in which a user 205 utilizes the electronic device 100 to view virtual content on a display 105. In some embodiments, the virtual content may be presented on the display 105 as part of an immersive experience. As such, the virtual content may include, for example, extended reality content, such as augmented reality content, virtual reality content, or the like that prevents the user from seeing at least a portion of the surrounding environment.

According to one or more embodiments, the electronic device 100 may be configured to determine whether a physical object exists in a region proximate to the user. In some embodiments, the electronic device 100 may be configured to quantize the proximate region to the device to determine whether particular portions of the environment are occupied or not. As shown, the environment may be quantized into voluminous regions of space 225A surrounding the user and/or the electronic device 100. The quantized regions may be, for example, 2D or 3D portions of the physical environment. In some embodiments, the regions may be determined based on a spatial relationship with the device such that the regions move through space as the device moves. For example, the regions 225A may be defined as having a fixed distance and orientation from the electronic device 100. In some embodiments, the distance of the blocks can be permanently defined by the device, or it can vary based on user setting input. Additionally, or alternatively, the distance and orientation of the blocks in relation to the device can dynamically change based on context. For instance, if the user is engaging in an activity that requires no or little movement, such as watching an immersive movie, and/or is in a small room or a cubicle, the user can minimize the distance to the farthest block 235A so that the existence of the wall is not constantly conveyed to the user, or the device can adjust it itself when it identifies that the movie app is running and the user is facing a close wall. If the device detects that the user is shifting position or has stood up and is starting to move, then the device can readjust the distance 235C back to a default. The set of regions 225 may be situated in a variety of configurations. For example, the set of regions 225 may be configured in a plane in front of the user, an arc, cylinder, or sphere surrounding the user, or the like.

According to one or more embodiments, the electronic device 100 may include sensors 210 which may be used to detect physical obstructions in the physical environment 120. For example, sensor 210 may include a depth sensor, LiDAR, or the like. As the electronic device 100 moves through the environment, a status can be determined for each region of the set of regions 225A. The status may be an occupied status if a physical object is detected in the region, an unoccupied status if the sensor data indicates that the region is free of physical objects, and an unknown status if not enough sensor data has been collected for a region for a determination to be made. In the example of FIG. 2A, the regions 225A in front of the device have been assigned statuses based on sensor data collected by sensor 210. As an example, blocks 230A and 235A are depicted as having an unoccupied status. According to some embodiments, a LIDAR signal may be used to determine that the depth of the desk 125 is outside the distance of the furthest block 235A from the device 100, thereby indicating that blocks between the device 100 and the desk 125 are unoccupied. Accordingly, block 230A and 235A are assigned an unoccupied status. Further, the region 225A includes blocks behind the device. For purposes of this example, block 240A of region 225A may be assigned an unknown status because the sensor is collecting data in front of the user 205 and the region 240A has not been observed yet by the sensor data collected by electronic device 100.

Turning to the example of FIG. 2B, the spatial relationship between the device 100 and the desk 125 has changed such that part of the desk 125 is located within the regions 225B tracked by the device. In some embodiments, regions 225 in front of the device may be assigned statuses based on additional sensor data collected by sensor 210 based on the change in relationship between the device 100 and the desk 125. Accordingly, block 230B is depicted as having an unoccupied status, whereas block 235B is depicted as having an occupied status because the legs of the physical desk 125 are within block 235B. According to some embodiments, a LIDAR signal may be used to determine that the depth of the desk 125 is within block 235B, thereby indicating that block 235B is occupied. In addition, by the nature of LiDAR signals moving through the physical environment 120, the blocks through which the LiDAR signal travels prior to block 235B when no intervening objects are present may be determined to be unoccupied, according to some embodiments. Further, for purposes of this example, block 240B of region 225B may continue to be assigned an unknown status because the sensor is collecting data in front of the user 205 and the region 240B has not been observed yet by the electronic device 100.

In some embodiments, a determination may be made as to whether the occupied block satisfies a particular closeness threshold for a particular visual treatment. In some embodiments, the closeness threshold may be based on a predetermined distance from the electronic device 100 and/or user 205 to the occupied block. Turning to FIG. 2C, an example is presented in which an additional visual treatment is applied to an occupied block based on a closeness threshold. the spatial relationship between the device 100 and the desk 125 has changed such that more of the desk 125 is located within the regions 225C tracked by the device. In some embodiments, regions 225C in front of the device may be assigned statuses based on additional sensor data collected by sensor 210 based on the change in relationship between the device 100 and the desk 125. Accordingly, both blocks 230C and 235C are depicted as having an occupied status because the physical desk 125 is located within blocks 230C and 235C. According to some embodiments, a LIDAR signal may be used to determine that the depth of the desk 125 is within block 235B, thereby indicating that block 235B is occupied. Further, for purposes of this example, block 240B of region 225B may continue to be assigned an unknown status because the sensor is collecting data in front of the user 205 and the region 240B has not been observed yet by the electronic device 100.

According to some embodiments, because the LiDAR signal may be used to determine that block 230C is occupied, block 235C may be assigned an occupied status based on being behind an occupied block from the point of view of the device 100. Alternatively, because the LiDAR signal may not receive data for block 235C (for example because the signals are reflected at block 230C in front of block 235C), then block 235C may be assigned an unknown status.

In some embodiments, multiple visual treatments may be applied to a block having an occupied status, for example, based on a distance from the device 100. In some embodiments, because the blocks may be situated in a fixed distance and orientation from the device 100, each block may be associated with a particular visual treatment (or combination of visual treatments) when the block is occupied, thereby inherently satisfying the closeness threshold. As an example, if block 230B is the closest occupied block to the electronic device 100, then a first visual treatment, such as visual treatment 130 of FIG. 1 may be applied, whereas if block 230A of FIG. 2 is the closest occupied block to the electronic device 100, then a second visual treatment may be applied, such as visual treatment 140 of FIG. 1. In addition, in some embodiments, visual treatments may also be applied to a block with an unoccupied status. The visual treatment applied when a block has an unknown status may be the same or different than when a block has an occupied status. Additionally, or alternatively, a closeness threshold may be the same or different for blocks with an occupied status and an unknown status in order to determine a visual treatment to apply or present on the display 105. As shown in the current example, the shading of blocks 230C and 235C are depicted in a darker color than the shading of block 235B of FIG. 2B, indicating that the blocks 230C and 235C, and therefore the object located within blocks 230C and 235C are closer to the device than the object located within block 235B.

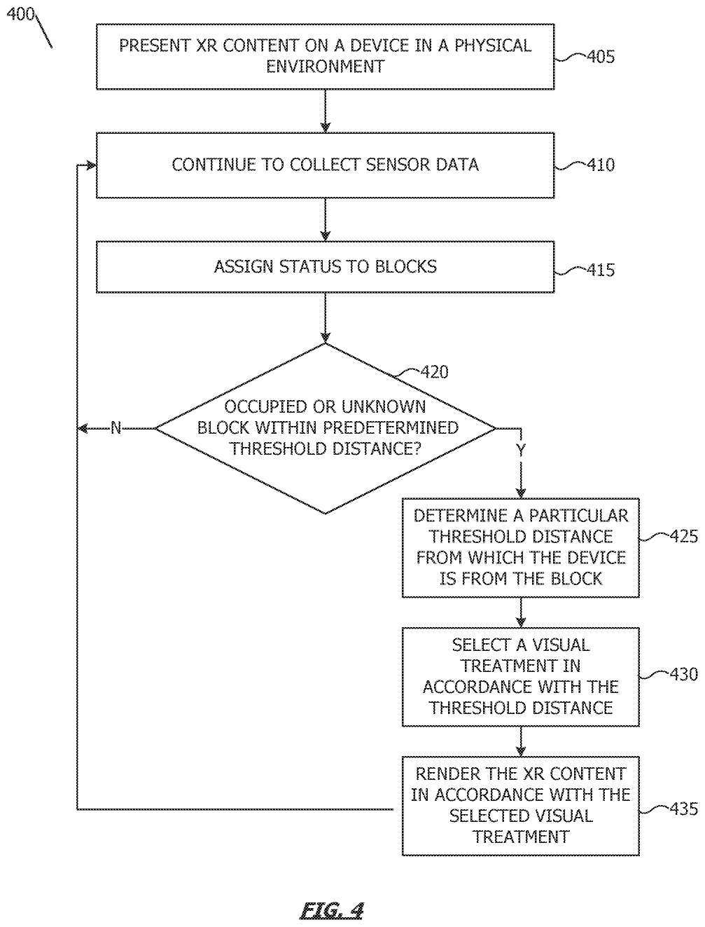

FIG. 3 shows, in flowchart form, a technique for assigning an occupied or unoccupied status to regions of the physical environment proximate to the electronic device and/or user. For purposes of explanation, the following steps will be described in the context of FIGS. 1-2. However, it should be understood that the various actions may be taken by alternate components. In addition, the various actions may be performed in a different order. Further, some actions may be performed simultaneously, and some may not be required, or others may be added.

The flowchart 300 begins at block 305 where the electronic device 100 collects sensor data for an environment. In particular, the electronic device 100 collects sensor data indicating the existence of and/or locations of physical objects within the environment. For example, in some embodiments, the electronic device may use such technology as a depth camera, LIDAR, or other technology which provides sensor data indicative of objects within a proximate area of the user. In some embodiments, the electronic device 100 may transmit a signal into the environment to detect whether any objects are in the environment, or may receive signal data and/or an indication from an additional device that a physical object exists in the environment. The physical object may be a static object, such as a wall, furniture, appliance, plants, or the like. Additionally, the physical object may include a dynamic object, such as other people, pets, animals, and other moving objects.

The flowchart 300 continues at block 310 where the electronic device identifies a set of blocks of space in the environment for which data is received. The particular set of blocks may be a set of two- or three-dimensional regions of space. The regions of space may be arranged in a 2-dimensional or 3-dimensional manner proximate to the device. For example, the blocks may be arranged in a plane in front of the electronic device and/or user, in an arc around the electronic device and/or user, in a cylinder around the electronic device and/or user where the axis of the cylinder is positioned vertically, in a sphere around the electronic device and/or user, or the like. In some embodiments, the blocks may be defined as regions of space with a predetermined relationship to the electronic device and/or user such that the location of the blocks move as the user moves. For example, the blocks may be locked into a configuration with respect to the device, such as a particular distance and orientation in relation to the device. Alternatively, in some embodiments, the blocks may be associated with static regions of the physical environment. For example, the blocks may be associated with a global coordinate system or a coordinate system common to the physical environment.

At block 315, a status is assigned to each block of the set of blocks. In some embodiments, the blocks most proximate to the electronic device may be set to an “unoccupied” status. Further, in some embodiments, the blocks may be associated with an “unknown” status until sufficient sensor data is collected to determine an “occupied” or “unoccupied” status for the block. To determine whether an object is present within a block, the electronic device 100 may use one or more sensors to determine depths of objects within the environment. For instance, a LiDAR device can transmit a signal through the physical environment and determine the position of an object based on a reflection of the signal from the object. At block 320, one or more blocks are identified for which the sensor data indicates the particular block includes a physical object. When the signal reflects off a physical surface in the physical environment, a physical object can be determined to be present, and, in some embodiments, the block can be assigned an occupied status, as shown at block 325. Accordingly, one or more blocks associated with the location of the reflection may be identified. In some embodiments, a filtering function or other treatment may be applied to the sensor data to determine whether a block should be considered “occupied.” For example, according to some embodiments, the electronic device may track for a threshold amount of data detecting a physical object to be reached to determine that a block is occupied. Additionally, or alternatively, the sensor data may be applied to an algorithm or trained network to determine a confidence value for the block. If the confidence value satisfies a predetermined confidence threshold, then the block can be determined to be “occupied” and the occupied status can be assigned.

Because the determination of the occupied status requires a determination that the signal passes through the environment, inferences may be made about blocks between the device and the occupied block, according to some embodiments. Accordingly, at block 330, the electronic device 100 determines the intervening blocks. In some embodiments, the determination is made based on blocks situated between the electronic device and the occupied block. For example, the blocks may be determined based on a determination that the signals that were used to detect the occupied block passed through the determined block. Then, at block 335, the determined blocks are assigned an “unoccupied” status.

The flowchart 300 continues at block 340 where a determination is made regarding whether additional sensor data is received. The additional sensor data may be received, for example, as the electronic device 100 moves within the environment 120. For example, the sensor(s) 210 may collect additional data as the electronic device 100 moves within the physical environment 120 or changes position or orientation within the physical environment. Further, additional data may be collected as time elapses which may indicate whether an object has entered a region proximate to the device even if the device has not moved. Additionally, or alternatively, in some embodiments, electronic device 100 may receive sensor data or other data related to the status of a particular block from other sources, such as other devices within the environment. Moreover, the If at block 340 additional sensor data is received, or additional data related to the status of a block being tracked by the electronic device, then the flowchart returns to block 310, the set of blocks for which data is received are identified, and the various blocks are re-assigned a status at block 315. The flowchart continues until no additional data is received. For example, if the user discontinues use of the electronic device, or the electronic device remains still. In some embodiments, a status for a particular block may be continuously updated as a user uses the electronic device 100 to maintain accurate status information.

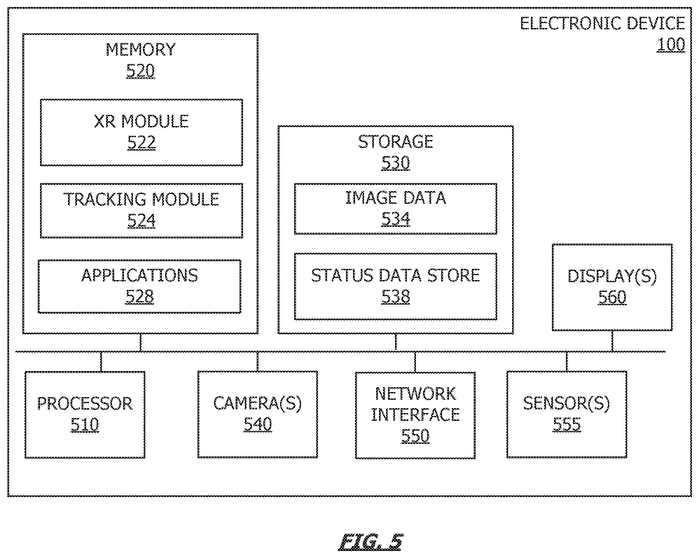

Turning to FIG. 4, a flowchart is depicted for a technique for applying a visual treatment to content presented on a display based on a proximity of a user and/or device to a physical object in a physical environment, according to one or more embodiments. For purposes of explanation, the following steps will be described in the context of FIGS. 1-2. However, it should be understood that the various actions may be taken by alternate components. In addition, the various actions may be performed in a different order. Further, some actions may be performed simultaneously, and some may not be required, or others may be added.

The flowchart begins at block 405 where an extended reality (“XR”) content is presented on a display of an electronic device. For example, referring back to FIG. 1, the XR content may be immersive content 110 presented on display 105 of electronic device 100. According to some embodiments, XR content may include immersive content, such as augmented reality content, virtual reality content, extended reality content, and the like. The XR content may be presented on an immersive display, such as a pass-through display, a display on a head-mounted device, or the like.

At block 410, senor data is collected by the device for the region defined by the blocks around the user and/or device. In some embodiments, additional sensor data may indicate a change in spatial relationship between objects in the environment and the device. According to some embodiments, a movement of the device may cause a change in the status of blocks around the user. For example, if the blocks are static in relation to the electronic device collecting data, then when the device changes orientation, the status of the blocks will change with their location in the physical environment. As such, a change in location and/or orientation of the electronic device may trigger the status information for the blocks to be reallocated. Additionally, or alternatively, a movement of an object in the environment may cause a change in status of a particular block even if the device does not move.

The flowchart 400 continues at block 415 where the status of the blocks is assigned. According to some embodiments, the updated status of the block may be determined based on new sensor data. Additionally, or alternatively, the sensor data and/or status information for a previous block may be utilized to determine a current status for a current block based on the movement of the device. For example, if a block is determined to be occupied, and the device turns 90 degrees, then a current block at the same location as the previous block may be assigned the occupied status based on the status of the block previously located at the same location in the environment. As another example, the status for the blocks may be determined based on new sensor data collected from the user using the technique described above with respect to FIG. 3.

The flowchart continues at block 420 where a determination is made as to whether a block with an occupied or unknown status is within a predetermined threshold distance of the electronic device. In some embodiments, because the blocks may be stationary in relation to the user, the blocks may be associated with a particular distance. In some embodiments, the threshold distance may be the same or different for occupied blocks and unknown blocks. That is, an occupied block at a particular distance from the device may satisfy the threshold distance, whereas the same block having an unknown status may not satisfy the threshold, as an example. Further, in some embodiments, the determination may be based on any block being an occupied and/or unknown status. That is, in some embodiments, the determination may be based on whether or not a block has an occupied status and may not require a determination of distance for the block. If, at block 420, a determination is made that no occupied or unknown block is within a threshold distance, then the flowchart reruns to 410 and the device continues to collect sensor data.

If at block 420 a determination is made that the distance to the block satisfies the predetermined threshold distance, then the flowchart continues to block 425, and the particular threshold distance is determined. As described above, different threshold distances may be associated with different treatments. As such, the particular threshold distance for the occupied or unknown block is determined. Then, at block 430, the visual treatment is selected in accordance with the threshold distance. The visual treatments provide a visual cue as to a physical obstruction and/or potential obstruction in the physical environment while causing minimal disruption to a user participating in an immersive experience via the electronic device. As such, the visual treatment may differ based on whether the block within the threshold distance is occupied or simply unknown. Further, the visual treatment may differ based on a distance the electronic device is from the occupied and/or unknown block. According to some embodiments, the visual treatment may include an overlay over the content presented on a display, such as a change in color or other image property, an additional animation, or a change in display property, such as triggering a pass-through display functionality. Additionally, or alternatively, a semi-transparent colored block may be presented coincident with the occupied block, and/or a change in color of a block indicative of a distance of the object to the device. The flowchart continues at block 435 where the electronic device 100 renders the XR content in accordance with the selected visual treatment. As such, the display 105 of the electronic device 100 may augment the presentation of the immersive content in accordance with the visual treatment. In some embodiments, while a predetermined threshold is reached, a presentation of a visual treatment may be modified as the user and/or device moves without a change in status of the blocks. For example, if a block in the environment is occupied and a threshold distance indicates an animation should be applied, the speed of the animation may change as the user approaches or moves away from the block. Because the blocks may move with the user, as the physical object causing the block to be occupied approaches a closer block to the user, the visual treatment may change. As another example, an opaqueness, a brightness, or other visual characteristics may change.

The flowchart returns to block 410, and the device continues to collect sensor data, which may cause a status to be reassigned to the blocks, as described above with respect to block 415. Further, if a determination is made that a block is no longer occupied and/or unknown, then the visual treatment may be augmented or removed.

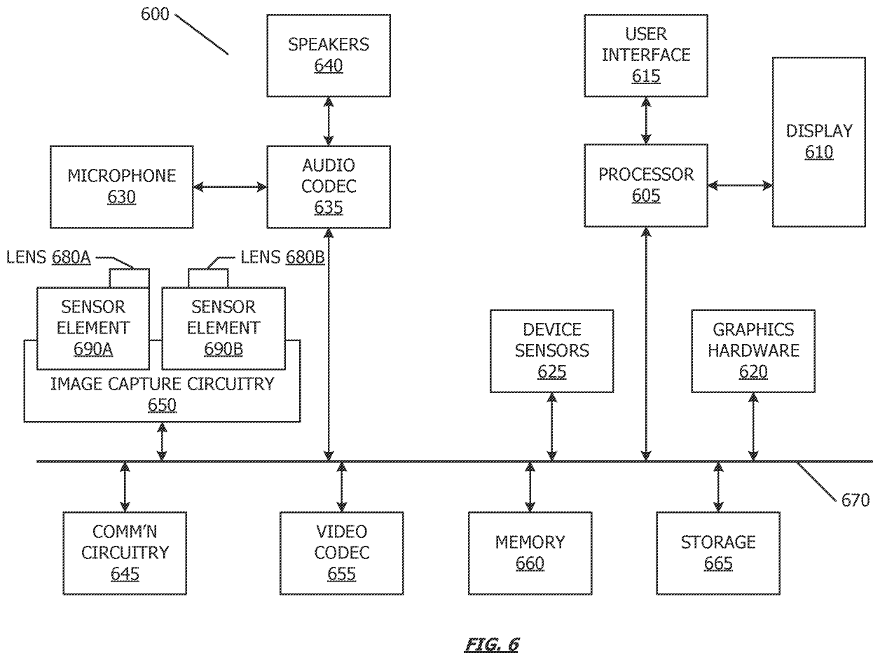

Referring to FIG. 5, a simplified block diagram of an electronic device 100 is depicted, in accordance with one or more embodiments of the disclosure. Electronic device 100 may be part of a multifunctional device, such as a mobile phone, tablet computer, personal digital assistant, portable music/video player, wearable device, or any other electronic device that includes a camera system. FIG. 5 shows, in block diagram form, an overall view of a system diagram capable of supporting proximity detection and breakthrough, according to one or more embodiments. Electronic device 100 may be connected to other network devices across a network via network interface 550, such as mobile devices, tablet devices, desktop devices, as well as network storage devices such as servers and the like. In some embodiments, electronic device 100 may communicably connect to other electronic devices via local networks to share sensor data and other information about a shared physical environment.

Electronic Device 100 may include processor 510, such as a central processing unit (CPU). Processor 510 may be a system-on-chip such as those found in mobile devices and include one or more dedicated graphics processing units (GPUs). Further, processor 510 may include multiple processors of the same or different type. Electronic Device 100 may also include a memory 520. Memory 520 may each include one or more different types of memory, which may be used for performing device functions in conjunction with processor 510. For example, memory 520 may include cache, ROM, and/or RAM. Memory 520 may store various programming modules during execution, including XR module 522, tracking module 524, and other various applications 528. According to some embodiments, XR module 522 may provide an immersive experience to the user, for example through augmented reality, virtual reality, extended reality, enhanced reality, and the like. Tracking module 524 may utilize data from camera(s) 540 and/or sensor(s) 555, such as proximity sensors, to determine a location of the electronic device 100 and/or other objects in the physical environment.

Electronic device 100 may also include one or more cameras 540. The camera(s) 540 may each include an image sensor, a lens stack, and other components that may be used to capture images. In one or more embodiments, the cameras may be directed in different directions in the electronic device. For example, a front-facing camera may be positioned in or on a first surface of the electronic device 100, while the back-facing camera may be positioned in or on a second surface of the electronic device 100. In some embodiments, camera(s) 540 may include one or more types of cameras, such as RGB cameras, depth cameras, and the like. Electronic device 100 may include one or more sensor(s) 555 which may be used to detect physical obstructions in an environment. Examples of the senor(s) 555 include LIDAR and the like.

In one or more embodiments, the electronic device 100 may also include a display 120. Display 120 may be any kind of display device, such as an LCD (liquid crystal display), LED (light-emitting diode) display, OLED (organic light-emitting diode) display, or the like. In addition, display 120 could be a semi-opaque display, such as a heads-up display, pass-through display, or the like. Display 120 may present content in association with XR module 522 or other applications 528.

Although electronic device 100 is depicted as comprising the numerous components described above, in one or more embodiments, the various components may be distributed across multiple devices. Further, additional components may be used and/or some combination of the functionality of any of the components may be combined.

Referring now to FIG. 6, a simplified functional block diagram of illustrative multifunction device 600 is shown according to one embodiment. Multifunction electronic device 600 may include processor 605, display 610, user interface 615, graphics hardware 620, sensors 625 (e.g., proximity sensor/ambient light sensor, accelerometer and/or gyroscope), microphone 630, audio codec(s) 635, speaker(s) 640, communications circuitry 645, digital image capture circuitry 650 (e.g., including camera system), video codec(s) 655 (e.g., in support of digital image capture unit), memory 660, storage device 665, and communications bus 670. Multifunction electronic device 600 may be, for example, a digital camera or a personal electronic device such as a personal media player, mobile telephone, head-mounted device, or a tablet computer.

Processor 605 may execute instructions necessary to carry out or control the operation of many functions performed by device 600 (e.g., the generation and/or processing of images as disclosed herein). Processor 605 may, for instance, drive display 610 and receive user input from user interface 615. User interface 615 may allow a user to interact with device 600. For example, user interface 615 can take a variety of forms, such as a button, keypad, dial, a click wheel, keyboard, display screen and/or a touch screen. Processor 605 may also, for example, be a system-on-chip such as those found in mobile devices and include a dedicated graphics processing unit (GPU). Processor 605 may be based on reduced instruction-set computer (RISC) or complex instruction-set computer (CISC) architectures or any other suitable architecture and may include one or more processing cores. Graphics hardware 620 may be special purpose computational hardware for processing graphics and/or assisting processor 605 to process graphics information. In one embodiment, graphics hardware 620 may include a programmable GPU.

Image capture circuitry 650 may include two (or more) lens assemblies 680A and 680B, where each lens assembly may have a separate focal length. For example, lens assembly 680A may have a short focal length relative to the focal length of lens assembly 680B. Each lens assembly may have a separate associated sensor element 690. Alternatively, two or more lens assemblies may share a common sensor element. Image capture circuitry 650 may capture still and/or video images. Output from image capture circuitry 650 may be processed, at least in part, by video codec(s) 655, and/or processor 605, and/or graphics hardware 620, and/or a dedicated image processing unit or pipeline incorporated within circuitry 650. Images so captured may be stored in memory 660 and/or storage 665.

Sensor and camera circuitry 650 may capture still and video images that may be processed in accordance with this disclosure, at least in part, by video codec(s) 655, and/or processor 605, and/or graphics hardware 620, and/or a dedicated image processing unit incorporated within circuitry 650. Images so captured may be stored in memory 660 and/or storage 665. Memory 660 may include one or more different types of media used by processor 605 and graphics hardware 620 to perform device functions. For example, memory 660 may include memory cache, read-only memory (ROM), and/or random access memory (RAM). Storage 665 may store media (e.g., audio, image, and video files), computer program instructions or software, preference information, device profile information, and any other suitable data. Storage 665 may include one more non-transitory computer-readable storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 660 and storage 665 may be used to tangibly retain computer program instructions or code organized into one or more modules and written in any desired computer programming language. When executed by, for example, processor 605, such computer program code may implement one or more of the methods described herein.

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The scope of the disclosed subject matter should be determined with reference to the appended claims, along with the full scope of equivalents to which such claims are entitled. In the appended claims, the terms “including” and “in which” are used as the plain-English equivalents of the respective terms “comprising” and “wherein.”

1. A method comprising:
collecting, by a first device, a first set of sensor data for an environment including an object;
identifying a plurality of regions within the environment, the plurality of regions positioned within a threshold distance to the first device;
determining, based on the first set of sensor data, that the object is positioned within a first region of the plurality of regions;
assigning an occupied status to the first region based on the determination that the object is positioned in the first region; and
rendering a first visual treatment to a visual representation of the first region, the first visual treatment indicating presence of the object within the first region.

2. The method of claim 1, wherein the first visual treatment comprises applying a shading to the at least one region of the environment having an occupied status.

3. The method of claim 2, wherein the shading is applied based on a distance of the at least one region from the first device.

4. The method of claim 1, wherein the first visual treatment comprises an animation applied to a virtual object displayed coincident with the at least one region of the environment having an occupied status.

5. The method of claim 1, further comprising:
in accordance with a determination that the first device satisfies a second predetermined closeness threshold to the at least one region of the environment assigned an occupied status, causing a second visual treatment to be rendered by the device.

6. The method of claim 5, wherein the second visual treatment comprises augmenting a presentation of a virtual object coincident with the at least one region of the environment such that the at least one region of the environment is visible.

7. The method of claim 1, wherein the at least one region of the environment is assigned the occupied status selected from a group consisting of the occupied status, an unoccupied status, and an unknown status.

8. The method of claim 1, further comprising:
receiving status information for a second one or more regions from a second device in the environment.

9. The method of claim 1, further comprising:
assigning an unoccupied status to a second one or more regions in accordance with a determination that the device has passed through a portion of the environment comprising the second one or more regions.

10. The method of claim 1, wherein the plurality of regions are situated in a consistent spatial relationship to the device.

11. The method of claim 1, wherein each of the plurality of regions comprise a volumetric portion of the environment.

12. The method of claim 1, further comprising:
determining a status for each of a plurality of regions of the environment, wherein at least one region of the environment is assigned an occupied status.

13. A system, comprising:
one or more sensors configured to collect sensor data for an environment including an object;
one or more display devices;
one or more processors; and
one or more memory devices communicably coupled to the one or more processors and comprising computer readable code executable by the one or more processors to:
identify a plurality of regions within the environment, the plurality of regions positioned within a threshold distance to the first device;
determine, based on the first set of sensor data, that the object is positioned within a first region of the plurality of regions;
assign an occupied status to the first region based on the determination that the object is positioned in the first region; and
render a first visual treatment to a visual representation of the first region, the first visual treatment indicating presence of the object within the first region.

14. The system of claim 13, wherein the first visual treatment comprises applying a shading to the at least one region of the environment having an occupied status.

15. The method of claim 14, wherein the shading is applied based on a distance of the at least one region from the first device.

16. The system of claim 13, wherein the first visual treatment comprises an animation applied to a virtual object displayed coincident with the at least one region of the environment having an occupied status.

17. A non-transitory computer readable medium comprising computer readable code executable by one or more processors to:
collect, by a first device, a first set of sensor data for an environment including an object;
identify a plurality of regions within the environment, the plurality of regions positioned within a threshold distance to the first device;
determine, based on the first set of sensor data, that the object is positioned within a first region of the plurality of regions;
assign an occupied status to the first region based on the determination that the object is positioned in the first region; and
render a first visual treatment to a visual representation of the first region, the first visual treatment indicating presence of the object within the first region.

18. The non-transitory computer readable medium of claim 17, further comprising computer readable code to:
in accordance with a determination that the first device satisfies a second predetermined closeness threshold to the at least one region of the environment assigned an occupied status, cause a second visual treatment to be rendered by the device.

19. The non-transitory computer readable medium of claim 18, wherein the second visual treatment comprises augmenting a presentation of a virtual object coincident with the at least one region of the environment such that the at least one region of the environment is visible.

20. The non-transitory computer readable medium of claim 18, further comprising computer readable code to:
assign an unoccupied status to a second one or more regions in accordance with a determination that the device has passed through a portion of the environment comprising the second one or more regions.
